(19) United States
(12) Patent Application Publication
(10) Pub. No.: US 2024/0102258 A1
(43) Pub. Date: Mar. 28, 2024

(54) METHOD AND SYSTEM OF ADAPTIVE LENSING FOR SEA WAVES

(71) Applicant: X Development LLC, Mountain View, CA (US)

(72) Inventors: Roy Beck-Barkai, Ramat HaSharon (IL); Sofia Belikovetsky, Ra'anana (IL); Ori Marcel Cheshnovsky, Ra'anana (IL)

(21) Appl. No.: 18/471,145

(22) Filed: Sep. 20, 2023

Related U.S. Application Data
(60) Provisional application No. 63/408,977, filed on Sep. 22, 2022.

(51) Int. Cl. E02B 7/00; E02B 8/04

(52) U.S. Cl. CPC E02B 7/005; E02B 8/045

(57) ABSTRACT

The present disclosure relates to a method of using a feedback loop from sensors to manipulate sea waves by applying concepts from optics interference and lensing. The method includes capturing, by one or more sensors, environmental data of an aquatic environment, wherein the environmental data relates to one or more of a wind speed, a wind direction, a wave pattern, a wave spectra, and a wave direction. The method includes analyzing, by one or more processors of a controller, the environmental data to identify a sensed environmental condition. Further, the method includes determining an optimal configuration of a wave interference device in the sensed environmental condition, wherein the controller is communicatively coupled to the wave interference device; and configuring the wave interference device to occupy the optimal configuration.

### CROSS-REFERENCE TO RELATED APPLICATIONS

This application claims the benefit of U.S. Provisional Application No. 63/408,977, filed Sep. 22, 2022, the contents of which are incorporated by reference herein.

### TECHNICAL FIELD

The present disclosure relates to methods and systems for manipulating sea waves, and in particular, to methods and systems for using feedback loops from sensors to manipulate sea waves by applying concepts from optics interference and lensing.

### BACKGROUND

Sea wave energy has huge potential with a global sum of up to 80 thousand terawatt-hour. However, energy from wave harvesting and manipulation is underutilized because the energy density is low, the sea's forces are dynamic and unpredictable, and the direction of the sea wave is changing.

### SUMMARY

Methods and systems for manipulating sea waves disclosed herein are inspired in part by concepts from optics interference and lensing. By creating an adaptive system of sea waves lensing, the methods and systems described herein may be configured to concentrate, deflect, and reflect the energy of incoming waves in a variety of applications and environments.

The present disclosure introduces sea wave manipulation and adaptive wave focusing feedback loop to increase effectiveness of harnessing energy from waves. Techniques can alleviate issues including an issue of wave characteristic irregularity (e.g., direction, wavelength, amplitude) by dynamically controlling actuating elements to manipulate an incoming wave towards a wave energy converter (WEC) or other location. Waves with different characteristics might require different configurations of objects, e.g., connected to actuators, to successfully manipulate a given wave.

The present disclosure proposes a method for dynamically manipulating waves. For example, a method can include dynamically deflecting and focusing sea waves in order to enhance the amplitude of waves and to reduce the required length of WECs. The method can include one or more feedback loops configured to optimize an arrival of a focused wave to a given WEC.

The present disclosure also provides a dynamic wave manipulating array (DWMA). The DWMA is an array of dynamic wave interaction elements configured to be immersed or to float on the water surface and that can be controlled individually or in groups to interact with incoming waves as described herein. A controlling device can obtain information that represents one or more incoming waves (for example using measurement or prediction database services) and use the obtained information to control a wave manipulating array. The controlling device can manipulate the array to focus a wave to a particular location—e.g., to maximize energy delivered to a WEC. The controlling device can use the obtained information to determine how to manipulate the array. In this way, the controlling device can use wave wavelength variation, height variation, or direction variation to offer specific manipulations to the array for specific waves or for specific times. The specific manipulations can be unique manipulations—e.g., resulting in a unique configuration of objects situated in the path of an incoming wave.

In accordance with a first aspect of the presently disclosed subject matter, there is provided a method in a water wave energy concentration system comprising an array of wave interaction elements disposed offshore configured to alter a phase and/or an amplitude of an incident water wave, said wave interaction elements being controllable for focusing said incident water wave on a focal area. The method comprises (a) obtaining data indicative of one or more current water wave attribute; (b) controlling dynamically one or more of said wave interaction elements to adjust the focusing of the incident water wave on the focal area using said data. In accordance with a variant of the first aspect of the present disclosure, controlling dynamically one or more of said wave interaction elements may be performed so as to change a propagation direction of the incident wave thereby diverting the wave (i.e., without focusing the wave into a focal area).

In addition, with the above features, the method according to this aspect of the presently disclosed subject matter can optionally comprise one or more of features (i) to (x) below, in any technically possible combination or permutation:
(i) the water wave attribute comprises water wave wavelength, water wave propagation direction, and/or water wave amplitude.
(ii) the controlling dynamically one or more of said wave interaction elements is performed to transform the incident water wave into a curved water wave converging toward said focal area.
(iii) the data is obtained repeatedly over time and wherein the controlling dynamically one or more of said wave interaction elements using said data comprises using the data obtained at several points in time.
(iv) the controlling dynamically one or more of said wave interaction elements comprises computing a desired phase and/or amplitude alteration for focusing the incident water wave to the focal area using the obtained current water wave attribute and controlling one or more of said wave interaction elements to achieve said desired phase and/or amplitude alteration.
(v) controlling dynamically one or more of said wave interaction elements comprises controlling individually said one or more wave interaction elements.
(vi) controlling dynamically one or more of said wave interaction elements comprises controlling subsets of wave interaction elements together.
(vii) the focal area is a water energy convertor located on a shore or in proximity of the shore.
(viii) a depth of at least some of the wave interaction elements in the array relative to water level is controllable.
(ix) an orientation of at least some of the wave interaction elements in the array is controllable.
(x) the focal area is a water energy convertor or a gravitational water energy reservoir depending on meteorological event or external energy need.

In accordance with a second aspect of the presently disclosed subject matter, there is provided an apparatus for use in a water wave energy concentration system comprising an array of wave interaction elements disposed offshore configured to alter a phase and/or an amplitude of an incident water wave, said wave interaction elements being controllable for focusing said incident water wave on a focal area, said apparatus being configured for performing the method according to the first aspect of the present disclosure.

The apparatus according to the second aspect of the presently disclosed subject matter can optionally comprise an input port configured to receive data indicative of one or more current water wave attributes; an actuator operatively coupled to the array of wave interaction elements and configured for controlling said wave interaction elements; and a processor operatively coupled to the actuator and to the input port and configured for: computing a desired phase and/or amplitude alteration for focusing the incident water wave to the focal area using the obtained current water wave attribute and; controlling one or more of said wave interaction elements to achieve said desired phase and/or amplitude alteration.

In accordance with a third aspect of the presently disclosed subject matter, there is provided water wave energy concentration system, comprising an array of wave interaction elements intended to be disposed offshore and configured to alter a phase and/or an amplitude of an incident water wave, said wave interaction elements being controllable for focusing said incident water wave on a focal area; and the apparatus according to the second aspect of the present disclosure.

The present disclosure also provides dynamically deflecting and focusing sea waves in order to enhance the amplitude of wave and to reduce the required length of hydroelectric wave energy convertors (WECs). The method herein disclosed uses feedback loops to optimize in real time the arrival of the focused wave to the WEC. The present disclosure includes a dynamic wave manipulating array (DWMA), a 2D formation of dynamic mechanical wave interaction elements that can be controlled individually or in groups, using prior information on the incoming waves to accommodate long time and short time variation of their wavelength, height and direction to optimize their focusing on the WEC.

In other words, the present disclosure provides a system in which the incoming waves may be focused to WEC, so that the enhanced energy density of the wave will provide high efficiency of wave energy to electricity conversion. Optionally, the focused wave may be directed to the energy conversion unit (WEC) or to a gravitational water energy reservoir, to compensate between excessive and low energy production periods. Optionally, the focused wave can be directed to a gravitational water energy reservoir in storm situation that cannot be handled by the WEC. Optionally, the focused wave will arrive to a movable WEC according to the predicted point of arrival. Optionally, the system is situated in deep water. Optionally, the focused wave may be directed off the WEC or any other shore structure or shore section that should be protected from excessive wave energy.

In a fourth example aspect, a method of manipulating waves using lensing may include capturing, by one or more sensors, environmental data of an aquatic environment. The environmental data may relate to one or more of a wind speed, a wind direction, a wave pattern, a wave spectra, a wave amplitude, and a wave direction. The method may include analyzing, by one or more processors of a controller, the environmental data to identify a sensed environmental condition. The method may further include determining an optimal configuration of a wave interference device in the sensed environmental condition, wherein the controller is communicatively coupled to the wave interference device. Further, the method may include configuring the wave interference device to occupy the optimal configuration.

In a fifth example aspect, a wave manipulation system for an aquatic environment may include a wave interference device comprising an interference structure arranged to concentrate, reflect, and/or deflect a wave. A controller may be communicatively coupled to the wave interference device and configured to move the interference structure. One or more sensors may be communicatively coupled to the controller and may be configured to capture environmental data of the aquatic environment.

In accordance with any one of the example aspects, the method of manipulating sea waves and a wave manipulation system for an aquatic environment may include any of the following:

In some examples, the interference structure may include a plurality of interference structures.

In one form, the method may include determining a desired manipulation of waves.

In another form, determining the optimal configuration may include determining the optimal configuration of the wave interference device in the sensed environmental condition according to a desired action.

In another example, configuring the wave interference device may include executing instructions, by the one or more processors, stored in a memory of the controller, the memory communicatively coupled to the one or more processors.

In one form, executing instructions may include sending a signal to the wave interference device to move one or more structures of the wave interference device from a first position to a second position.

In another form, configuring the wave interference device may include moving one or more structures of the wave interference device in a translational and/or rotational direction and/or depth below sea level.

In some forms, the method may include predicting an approaching wave pattern.

In other forms, the method may include processing historical data stored in a memory of the one or more processors.

In some forms, the method may include processing topographic data.

In some examples, the method may include processing weather forecasting.

In yet another form, analyzing may include comparing the environmental data to an environmental data stored on a memory of the controller.

In some examples, the interference structure may have an adjustable height.

In other examples, the interference structure may be rotatable about an axis of rotation.

In one example, the interference structure may be a stream of bubbles provided by the wave interference device.

In another example, the interference structure may be pivotable about a pivot axis.

In one aspect, a first interference structure of plurality of interference structures may be positioned at a different depth below a water surface than a second interference structure.

In some aspects, the controller may include a memory communicatively coupled to the one or more processors.

In some examples, the memory may store executable instructions that, when executed by the one or more processors, causes the one or more processors to receive environmental data captured by the one or more sensors, analyze the environmental data to identify an environmental condition associated with the aquatic environment, and send a signal to the wave interference device to occupy a position in response to the environmental condition.

In other aspects, the interference structure may move from a first position to a second position in response to a command transmitted by the controller.

In yet another aspect, the interference structure may change shape in response to a command transmitted by the controller.

In other form, two or more of a plurality of interference structures may change their spacing or the symmetry of their arrangement to combine focal change and/or deflection.

In some forms, the environmental data may relate to one or more of a wind speed, a wind direction, a wave pattern, a wave spectra, and a wave direction.

In other forms, the interference structure may include a plurality of rods arranged in an elliptical arrangement.

In one form, the interference structure may include a plurality of fins.

In other examples, the interference structure may have a varying cross-section extending along a length of the interference structure.

In other example, the system may include a second set of plurality of interference structures spaced from the plurality of interference structures.

In some examples, the second set may be arranged in a shape different than the plurality of interference structures.

### Definitions

As used herein, the term “about” means +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

Some examples may be described using the expression “coupled” and “connected” along with their derivatives. For example, some arrangements may be described using the term “coupled” to indicate that two or more elements are in direct physical or electrical contact. The term “coupled,” however, may also mean that two or more elements are not in direct contact with each other, yet still co-operate or interact with each other. The examples described herein are not limited in this context.

Other features and advantages of the present disclosure will be apparent from the following detailed description, figures, and claims.

### BRIEF DESCRIPTION OF THE DRAWINGS

FIG. 1A is a schematic diagram of an example wave manipulation system in accordance with the teachings of the present disclosure;

FIG. 1B is top view schematic diagram of an example wave manipulation system, showing alternative lens arrangements;

FIG. 1C is another top view schematic diagram of an example wave manipulation system, showing wave conditions as a result of alternative lens geometries and arrangements;

FIG. 2 is a first example of a wave interference device of any of the systems of FIGS. 1A-1C, assembled in accordance with the teachings of the present disclosure;

FIG. 3A is a cross-sectional view of a first example interference structure of the wave interference device of FIG. 2;

FIG. 3B is a cross-sectional view of a second example interference structure of the wave interference device of FIG. 2;

FIG. 3C is a cross-sectional view of a third example interference structure of the wave interference device of FIG. 2;

FIG. 4 is another example of a wave interference device of any of the systems of FIGS. 1A-1C in an aquatic environment, assembled in accordance with the teachings of the present disclosure;

FIG. 5 is a different example of a wave interference device of any of the systems of FIGS. 1A-1C, assembled in accordance with the teachings of the present disclosure;

FIG. 6 is a perspective view of another example of a wave interference device of any of the systems of FIGS. 1A-1C, assembled in an aquatic environment in accordance with the teachings of the present disclosure;

FIG. 7 is a top view of the wave interference device of FIG. 6;

FIG. 8 is a side view of an example wave interference structure of a wave interference device, assembled in accordance with the teachings of the present disclosure;

FIG. 9 is side view of an example wave interference device, assembled in accordance with the teachings of the present disclosure;

FIG. 10 is a schematic diagram of a method of manipulating sea waves using feedback decision making on the nature of operation and using lensing in accordance with the teachings of the present disclosure;

FIG. 11 illustrates schematically a water wave energy concentration system in accordance with embodiments of the present disclosure; and

FIG. 12 illustrates several examples of wave manipulation according to some embodiments of the present disclosure.

Like reference numbers and designations in the various drawings indicate like elements.

### DETAILED DESCRIPTION

Methods and systems for manipulating sea waves disclosed herein are inspired in part by concepts from optics interference and lensing. By creating an adaptive system of sea waves lensing, the methods and systems described herein may be configured to concentrate, deflect, and reflect the energy of incoming waves in a variety of applications and environments.

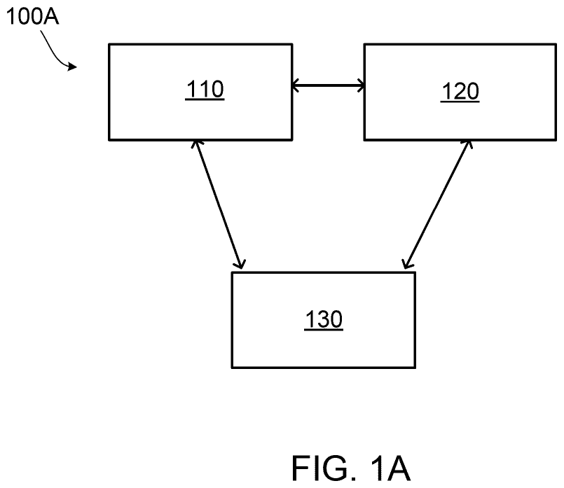

In FIG. 1A, an example wave manipulation system 100A of the present disclosure includes one or more sensors of a sensor system 110 that captures environmental data of an aquatic environment (including wave patterns), a control system 120 that receives and analyzes the sensed environmental data and computationally estimates an optimal configuration for manipulating the incoming waves, and a wave interference device 130 that physically adapts structures that interfere with the incoming wave for optimal application of the waves. The wave interference device 130 can include a plurality of interference structures arranged to concentrate, reflect, and/or deflect a wave. FIGS. 1B and 1C show variations of the system 100A. Generally, the one or more sensors of the sensor system 110 captures environmental data related to the aquatic environment, and communicates the environmental data to the control system 120, which analyzes and processes the data to identify an environmental condition and determine an optimal configuration for harnessing the wave energy. The control system 120, which is communicatively coupled to the wave interference device 130, communicates with the wave interference device 130 to move one or more of the plurality of interference structures to arrange the wave interference device in an optimal position for energy capture and harvesting.

In some examples, the system 120 will receive external guidance and monitoring to ensure that the system 100A is performing correctly. For example, by monitoring energy generation, the system 120 may be connected to a wave energy capture (WEC) device to analyze that the system 100A actually increases the capacity factor that is expected. This feedback loop can help system 120 control the lens in the right way, e.g., to increase the amount of energy available for the WEC device.

The sensor system 110 may include one or more sensors disposed on or spaced away from the wave interference device 130. For example, in FIG. 1B, the sensor system 110 includes a plurality of individual sensors 110 spaced between incoming waves 242 and the wave interference device 130, on the wave interference device 130, and downstream from the wave interference device 130. The sensor system 110 is configured to capture environmental data, e.g., wave patterns or weather conditions, of the aquatic environment in which the wave interference device 130 is located. The sensor system 110 is communicatively coupled to the control system 120. The control system 120 receives the environmental data from the sensor system 110 to configure the wave interference device 130. The sensor system 110 may include various techniques and types of sensing devices to capture data related to incoming waves, such as patterns, spectra, and direction. Such devices and techniques may include, for example, physical wave sensors disposed upstream the wave interference device, physical wave sensors on the wave interference device, physical wave sensors downstream the wave interference device, imaging sensors on the shore, on inspection towers, at sea, or via satellites, drones, and/or wind speed and direction at the sea and/or near the wave interference device. Another possibility is the usage of available public or commercial predictive models and databases on waves and wind conditions, e.g., the sensor system 100 can use public or commercial predictive models and databases on waves and wind conditions to generate environmental data to inform control actions performed by the control system 120.

The control system 120 (FIGS. 1A and 1B) is communicatively coupled to both the sensor system 110 and the wave interference device 130, and determines an optimal configuration of the wave interference device 130 based on the conditions of the surrounding aquatic environment and on the required operation, such as, for example, wave focusing or wave deflection. Using analytical computation, hydrodynamic simulation, and/or machine learning algorithms, the control system 120 can predict the approaching wave pattern and estimate an optimal configuration of the wave interference device 130 for the desired application. For example, in FIG. 1B, the wave interference device 130 can occupy one or more positions relative to the incoming waves 242. The inputs for the computation may include the following: sensor data, historical data, topographic data, weather forecasting and current weather events, safety and regulatory consolidations, various configurations of the wave interference device 130, and/or optimal needs by the application. The output of the computational process may include the following: desired configuration of the wave interference device 130, warnings regarding higher/lower out-of-bound incoming and outgoing wave, energy estimates for outgoing energy power density, spectra and spatial distribution, post the wave interference device, prediction of coastal erosion, and/or prediction for temporal energy harvesting.

The wave interference device 130 includes physically adaptive structures (e.g., rods, fins, planks, bubble streams, etc.) that are configured to manipulate or interfere with a sea wave for energy amplification of the incoming waves. The structures are movable and/or controllable to adapt the wave interference device 130. Waves can interact with obstacles near and at the water/air interface. Therefore, the manipulation device may include adjustable and/or movable parts that either increase or decrease their local interactions with the waves. In FIG. 1C, a plurality of interference devices 131 are dispersed in an area. Each of the wave interference devices 130 may respond to distorted wave fronts 242 as depicted in FIG. 1C. As shown in FIG. 1C, the various interference devices 130 are non-uniformly spaced apart and have varying shapes.

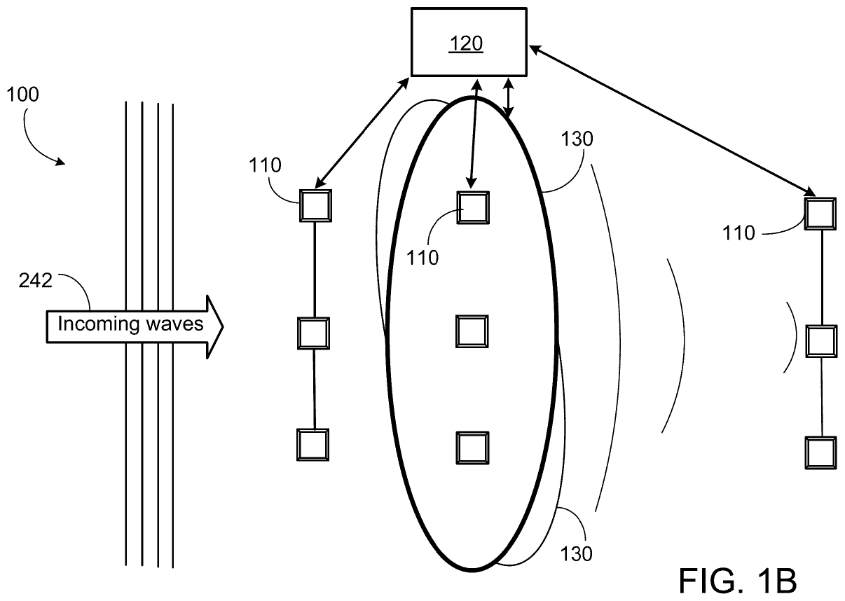

In FIG. 2, an example arrangement of a wave interference device 130 includes a base 138 and the plurality of interference structures 134 extending from the base 138. The interference structures 134 are collectively and individually arranged to interfere with the sea waves by analogy to the physical laws from the field of optics. The interference structures 134 are movable, as a group or individually, and may include adaptive rods, plates, fins, surfaces, and/or pipes. For example, in FIG. 2, the interference structures 134 are plurality of evenly spaced, parallel rods, distributed in a plurality of rows. Each rod 134 can be adjustable in height, angular orientation, and/or cross-sectional shape 142. Adaptive plates, fins, or other surfaces can be brought closer to the water-air interface to change their directions and/or profile. In some examples, the interference structures 134 are pipes that create an adaptive flow of gas and/or liquids that can change the flow speed, and/or type of gas/liquid and/or temporal pattern of release.

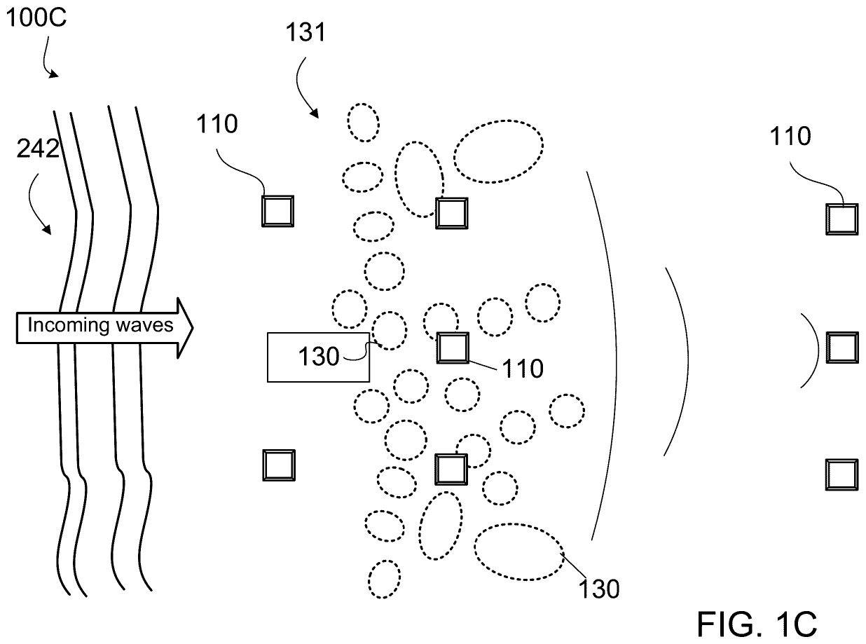

The wave interference device 130 may be customized according to application. While the illustrated example in FIG. 3A-3C depicts the interference structures 134A-C disposed in an elliptical arrangement on the base 138, the arrangement of interference structures 134 may be a disposed in a plurality of rows and/or columns or otherwise to assemble a variety of different shapes to affect the amplitude of the incoming wave. One or more of the plurality of interference structures 134 may be rotatable and/or translatable about a central axis A. In some examples, the angular orientation of one or more of the interference structures 134A-C may be adjusted so that some or all of interference structures 134A-C are non-parallel relative to each other.

The cross-sectional shape 142A-C of one or more of the interference structures 134A-C may be arranged so that rotating the structures 134A-C relative to the central axis A changes how the interference structures 134 manipulate the incoming wave. For example, FIG. 3A illustrates a first example interference structure 134A that is a rod having an oval cross-sectional shape 142A. In FIG. 3B, another example rod 134B has a crescent-like cross-sectional shape 142B; and in FIG. 3C, another example interference structure 134C is a slender fin with an arcuate cross-sectional shape 142C. One or more of these or other shapes may be implemented in a single wave interference device to manipulate or shape the incoming waves in a desired manner.

In other examples, the interference structures 134A-C may be more than one material, with different surface treatments, and/or varying porosity. In some examples, the plurality of interference structures 134A-C may be uniformly distributed on the base 138 and move together. In other examples, the interference structures 134A-C of an interference device 130 may vary in cross-sectional shape, height, thickness, material, angular placement relative to the base 138, and/or ability to move. Further, in some applications, the interference structures 134A-C may be fully submerged or partially submerged under water.

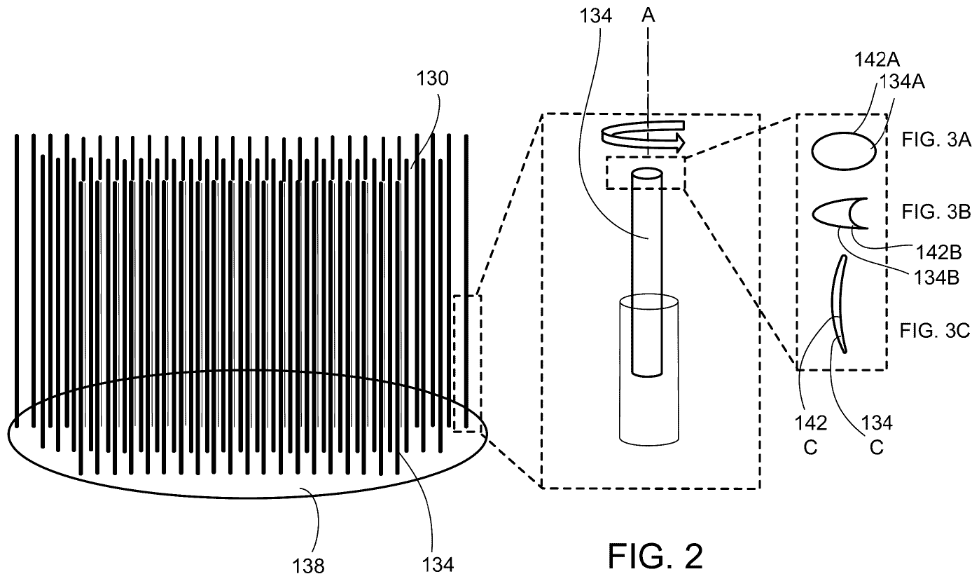

Turning to FIG. 4, a wave manipulation assembly 200 including an example wave interference device 230 is assembled in accordance with the teachings of the present disclosure. The interference device 230 may be the same or similar to the interference device 130 of FIGS. 1-2. Thus, for ease of reference, and to the extent possible, the same or similar components of the interference device 230 will retain the same reference numbers as outlined above with respect to the first interference device 130, although the reference numbers will be increased by 100.

The assembly 200 includes the interference device 230, one or more sensors 260, and anchors 240 tethering the device 230 to a seafloor 232 using mooring lines 233. Given the slack of the mooring lines 233, the entire interference device 230 may be movable. In some examples, the interference device 230 may be movable up to 90 degrees in each direction. In the illustrated diagram, a wave 242 enters a first side 244 of the wave interference device 230 at a first amplitude 256, and exits through a second, opposite side 252 of the wave interference device 230 at a second concentrated amplitude 256. If, for example, the waves are approaching the interference device 230 at a different angle, then the device 230 may be positioned by translating and/or rotating the device 230 to better interact with the incoming waves. The assembly 200 is arranged for communicatively coupling with a controller of a control system, such as the control system 120 of the manipulation system 100A, to operate the assembly 200.

The assembly 200 includes one or more sensors 260 of a sensor system 110 configured to capture environmental data. In the illustrated example, a sensor 260 is attached to an interference structure 234, and another sensor 260 is attached to an anchor 240 located upstream the interference device 230. However, in other examples, additional sensors 260 may be placed at various points on and/or around the interference device 230.

In the illustrated example of FIG. 4, the interference device 230 concentrates the sea wave to create one or more focal zones that center the energy of the wave or enhance its height. In other examples, the wave interference device 230 may be arranged to deflect or break the sea wave to prevent the destructive forces from reaching the shore/passing the manipulation device. In yet other examples, the wave interference device 230 may be arranged to reflect the sea wave back to the sea to either create one or more focal zones or to counteract other incoming waves.

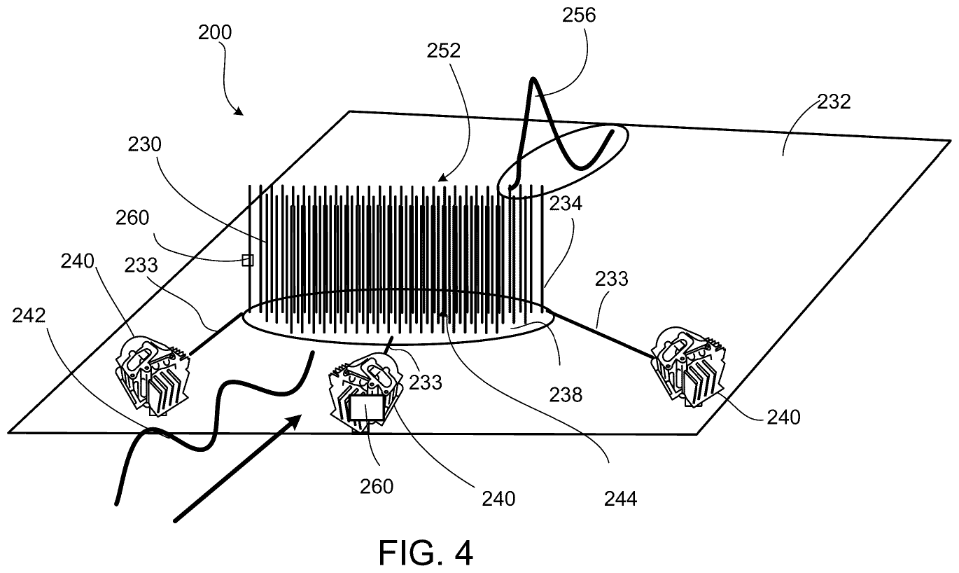

As illustrated in FIG. 5, a third example of a wave interference device 330 is constructed in accordance with the teachings of the present disclosure. The interference device 330 is similar to the interference device 130 of FIG. 2, and may be used with any of the systems 100A-C of FIGS. 1A-1C. Thus, for ease of reference, and to the extent possible, the same or similar components of the interference device 330 will retain the same reference numbers as outlined above with respect to the first interference device 130, although the reference numbers will be increased by 200.

The interference device 330 includes a plurality of separated sections 336 of interference structures 334 disposed in series to form a staggered, elliptical shape. The plurality of sections 336 can be arranged at varying distances relative to each other and in one of a variety of orders to achieve a desired interference device arrangement. In some examples, the sections 336 are anchored to a seabed with mooring lines 333 to allow for the distance between sections 336 to change to accommodate changing wave periods. The interference device 330 includes six different sections 336, and each section 336 has a plurality of interference structures 334. The interference structures 334 of each section 336 are uniform, however, in other examples, the interference structures 334 may vary relative to each other or to the interference structures 334 of the other sections 336 in number, shape, size, material, porosity, movability, cross-sectional shape, and angular orientation relative to the base 338. Due to the modularity of the interference device 330, the shape and configuration may be altered on site.

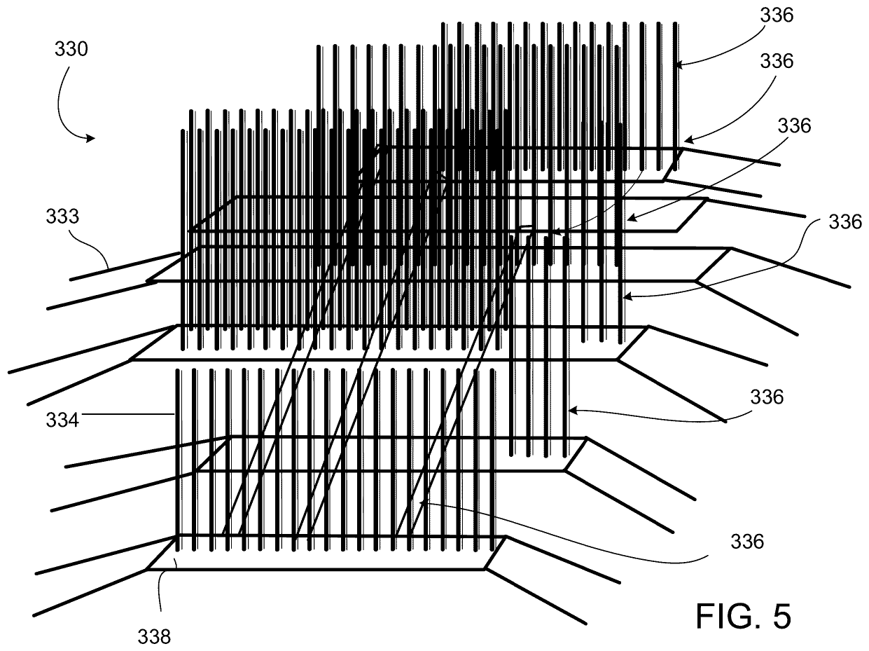

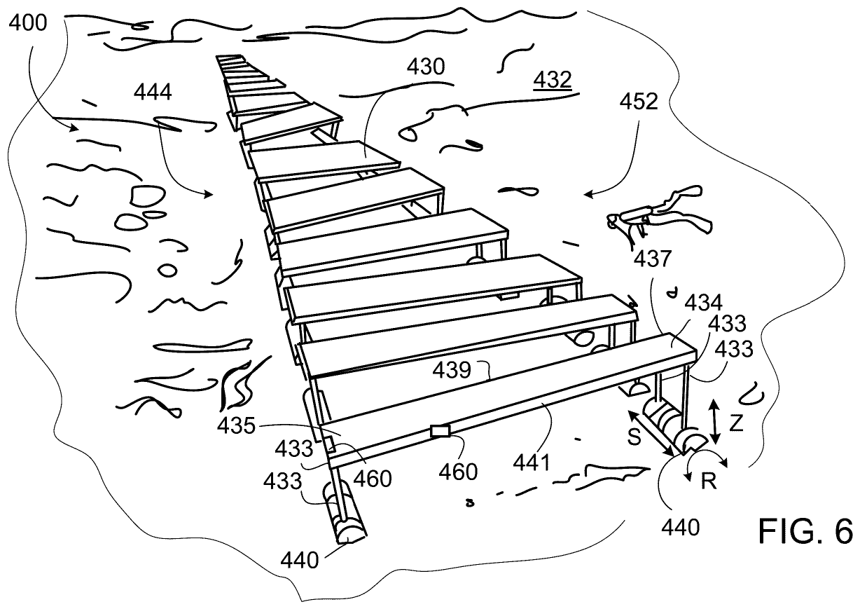

Turning to FIGS. 6 and 7, a wave manipulation assembly 400 includes another example wave interference device 430, one or more sensors 460, and anchors 440 tethering the device 430 to a seafloor 432 using mooring lines 433. While the interference device 430 differs from the interference devices 130, 230, and 330 of FIGS. 1-5, the interference device 430 is also configured to adapt interference structures 434 to interfere with the incoming wave for optimal application of the waves. Thus, the assembly 400 is similar to the assembly 200 of FIG. 4. Accordingly, for ease of reference, and to the extent possible, the same or similar components of the assembly 400 will retain the same reference numbers as outlined above with respect to the second manipulation assembly 200, although the reference numbers will be increased by 200.

The interference device 430 includes a plurality of planks or interference structures 434, where each plank is tethered to the seafloor 432 using mooring lines 433 and two anchors 440. So configured, a wave enters a first side 444 of the wave interference device 430 at a first amplitude, and exits through a second, opposite side 452 of the wave interference device 430 at a second concentrated amplitude. If, for example, the waves approach the interference device 430 at a different angle, then the device 430 may be positioned by rotating the device 430 to better interact with the incoming waves. The assembly 400 is arranged for communicatively coupling with a controller of a control system, such as the control system 120 of the manipulation system 100A, to operate the assembly 400.

The interference structures 434 are arranged to concentrate, reflect, and/or deflect waves in an aquatic environment. The interference structures 434 are collectively and individually arranged to interfere with the sea waves by analogy to the physical laws from the field of optics. The interference structures 434 are movable, as a group or individually. For example, in FIGS. 6 and 7, the interference structures 434 are plurality of planks having varying thicknesses T and spaces D between one another. Each interference structure 434 can move in a Z direction to adjust distance between the structure 434 and the seabed 432, in R and L directions to adjust angular orientation, in an X direction, and in an S direction to adjust a distance between neighboring planks 434.

In FIG. 6, the two parallel anchors 440 can rotate, release, and retract the mooring lines 433 connected to each interference structure 434 to adjust the placement of the interference structure 434. Specifically, two mooring lines 433 from each anchor 440 attach to each of the first and second ends 435, 437 of the interference structure 434. When the mooring lines 433 are adjusted, the angle between the first and second ends 435, 437 and/or the angle between first and second sides 439, 441 of each interference structure 434 may be adjusted. Each mooring line 433 is independently adjustable to vary angular orientation of each interference structure 434.

The wave interference device 430 may be customized according to application. While the illustrated example in FIGS. 6 and 7 depicts the interference structures 434 disposed in a linear arrangement, the arrangement of interference structures 434 may be a disposed in a columns, non-parallel, staggered, or assembled otherwise in a variety of different shapes to affect the amplitude of the incoming wave.

The assembly 400 includes a plurality of sensors 460 of a sensor system configured to capture environmental data. In the illustrated example, two sensors 460 are attached to the interference structure 434, and another sensor 460 is attached to an anchor 440. However, in other examples, sensors 460 may be placed at various points on and/or around the interference device 430.

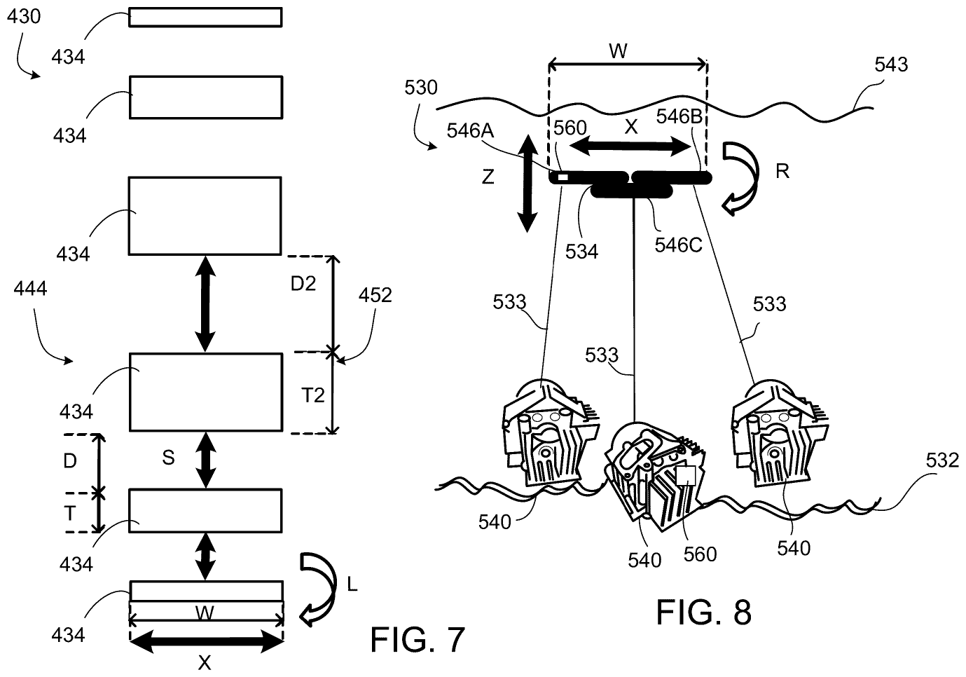

In FIG. 8, a different example an interference device 530, similar to the interference device 430, is shown. An interference structure 534 of the device 530 is tethered to a seabed 532 by three separate anchors 540 via with mooring lines 533 to allow for the distance between other interference structures 534 to change to accommodate changing wave periods. The anchors 540 are configured to adjust the slack in each mooring line 533 to adjust the interference structure 534 relative to the seabed 532 and a water surface 543. The mooring lines 533 can adjust in a Z direction to change a distance between the interference structure 534 and the surface of the water 543; in an X direction to change a width W of the interference structure 534; and in an R direction to adjust the angular placement relative to the seabed 532. The interference structure 534 includes first, second, and third boards 546A, 546B, 546C coupled together, and configured to move relative to one another to change shape and dimension of the overall interference structure 534. For example, the first and second boards 546A, 546B may move away from one another (i.e., relative to direction X), while remaining connected to the third board 546B, to increase a width W of the overall interference structure 534. Other interference structures 534 may be similarly adjustable.

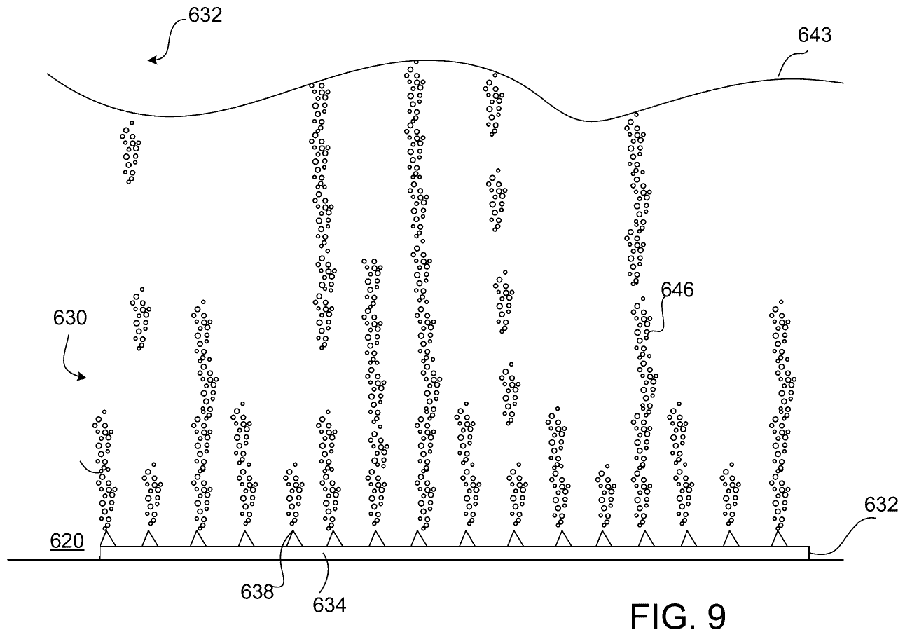

FIG. 9 is a different example of an interference device 630 that is configured to release gas or fluid to create streams of bubbles 646 to act as diffracting elements. By providing bubbles in a certain area, the interference device 630 can effectively change the local density of the water. For example, using dedicated air flow through controlled nozzles located below the propagating wave can effectively change the waves' propagation in a local manner and thus create a local phase delay that will manipulate the ocean conditions. Specific nozzles are actuated based on the sensors system for optimal manipulation.

The device 630 may be a standalone structure, as shown in FIG. 9, or may be integrated with the interference structures of the interference devices of FIGS. 1-8. For example, one or more rods 134, 234, 334 of the interference devices 130, 230, 330 of FIGS. 2-5 and/or one or more planks 434, 534 of the interference devices 430, 530 of FIGS. 6-8 may include nozzles or orifices that release gas or fluid to create bubble streams 646. In some examples, the device 630 may be combined with the other devices 120, 230, 330, 430, 530.

The device 630 of FIG. 9 includes tubing 634 with a plurality of spaced apart nozzles 638 and a control system 620 operatively coupled to the device 630. The device 630 is disposed below a water surface 643 to provide streams of bubbles 646 between the water surface 643 and the device 630. The tubing 634 is arranged in a linear strip, and may be arranged with a plurality of similar devices 630. In other examples, the tubing 634 may be configured in a variety of different shapes, such as elliptical, circular, polygonal, etc.

Much like the control systems described above, the control system 620 is communicatively coupled to the device 630 and sensors disposed in and around the environment. In this example, the control system 620 controls the release of gas or fluid through the nozzles 638 based on sensor feedback. The control system 620 may be remotely operated by a user, or may be pre-programmed to operate the device 630 in various wave conditions.

The device 630 includes 16 nozzles 638, each nozzle 638 being separably controllable to release bubbles 646 towards the water surface 643. The parameters of releasing gas or fluid at each nozzle 638 may vary to provide different concentration effects. For example, some nozzles 638 may be controlled to release bubbles in short bursts, whereas other nozzles 638 may be controlled to release bubbles in steady streams. In other examples, the control system 620 does not individually control each nozzle 638, but controls the nozzles 638 collectively. Other example devices may have more or fewer nozzles 638. The nozzles 638 may be uniform or they may be different to produce different bubble streams.

In the illustrated example of FIGS. 1-9, the interference devices 130, 230, 330, 430, 530, 630 concentrate the sea waves to create one or more focal zones that center the energy of the wave or enhance its height. In other examples, the wave interference devices 130, 230, 330, 430, 530, 630 may be arranged to deflect or break the sea wave to prevent the destructive forces from reaching the shore/passing the manipulation device. In yet other examples, the wave interference device 130, 230, 330, 430, 530, 630 may be arranged to reflect the sea wave back to the sea to either create one or more focal zones or to counteract other incoming waves. One or more structures of the various wave interference devices 130, 230, 330, 430, 530, 630 may be combined to create various iterations of wave interference devices.

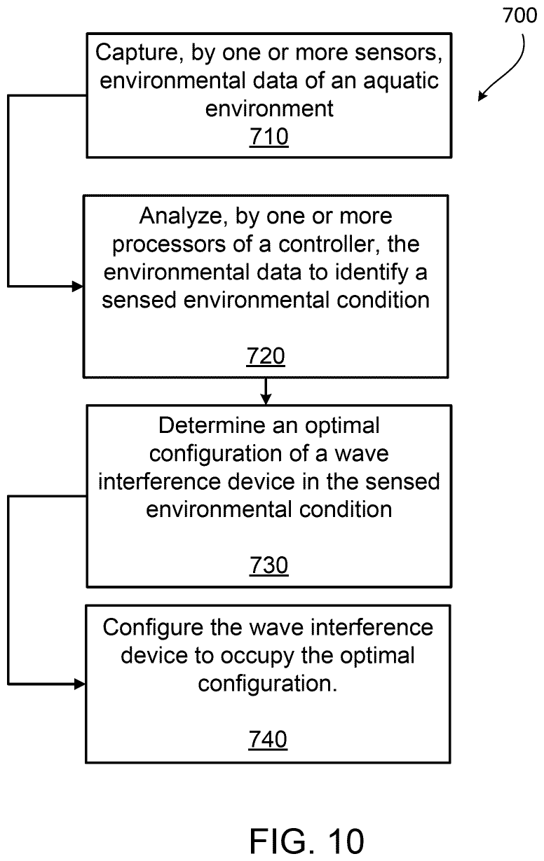

Turning now to FIG. 10, a diagram of an example method 700 of manipulating waves using lensing will be described with reference to the manipulation system 100A of FIGS. 1A and 2. However, the method 700 may also be performed using any of the interference devices of FIGS. 3-9. The method 700 includes capturing 710, by one or more sensors of a sensor system 110, environmental data of an aquatic environment, wherein the environmental data relates to one or more of a wind speed, a wind direction, a wave pattern, a wave spectra, and a wave direction. The method 700 includes analyzing 720, by one or more processors of a controller 120, the environmental data to identify a sensed environmental condition. The method 700 includes determining 730 an optimal configuration of a wave interference device 130 in the sensed environmental condition, and in response to the determination of the optimal configuration, the method 700 includes configuring 740 the wave interference device 130 to occupy the optimal configuration. In some implementations, the method 700 includes determining an action of wave manipulation. For example, the control system 120 can obtain a user instruction or determine, using one or more items of environmental data, an action of wave manipulation. An action of wave manipulation can include reflecting a wave, concentrating power of a wave, e.g., towards a WEC, dissipating power of a wave, or a combination of one or more of these.

Configuring 740 the wave interference device 130 includes executing instructions, by the one or more processors, stored in a memory of the controller 120 or computed anew based on the real-time sensor information. The memory is communicatively coupled to the one or more processors. Executing instructions includes sending a signal to the wave interference device 130 to move one or more structures 134 of the wave interference device 130 from a first position to a second position. The controller 120 can move the one or more structures 134 of the wave interference device 130 in translational, rotational, and/or depth directions.

Analyzing 720 the environmental data to identify a sensed environmental condition includes comparing the environmental data to an environmental data stored on a memory of the controller 120 or computed anew based on the real-time sensor information. The controller 120 can also process historical data, topographic data, and weather forecasting stored in a memory to identify the sensed environmental condition.

The present disclosure encompasses methods of creating an adaptive system for concentrating, deflecting, and/or reflecting wave energy. The method 700 of manipulating waves using lensing and the wave manipulation systems 100A-C, assemblies 200, 400, and devices 130, 230, 330, 430, 530, 630 of the present disclosure provide dynamic solutions to maximize energy output of the natural formation of waves by manipulating the waves to fit a particular harvesting device. As provided herein, any of the devices 130, 230, 330, 430, 530, and 630 may be used in any of the manipulation systems 100A-C of FIGS. 1-C. The systems and method are customizable, based on application, and can change with the strength, frequency, and direction of the waves and currents. Applications for the disclosed methods and systems may be, for example, energy harvesting, coastal erosion prevention, marine life manipulation and preservation, artificial highways for optimal maritime transportation, maritime natural disasters intervention and prevention, and recreation.

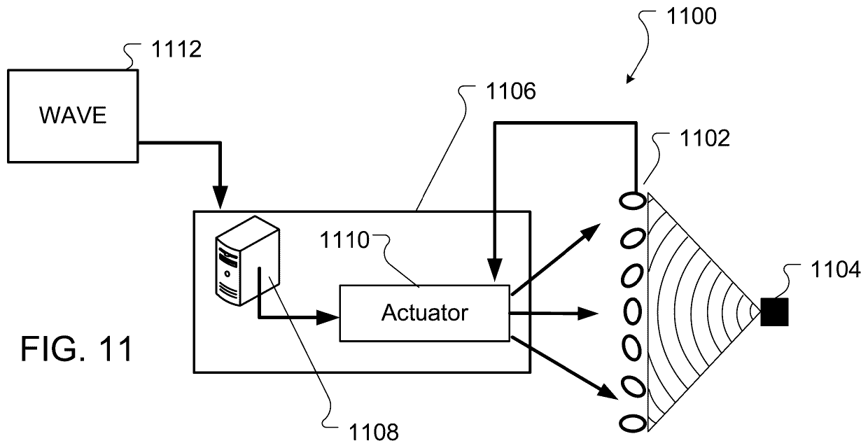

FIG. 11 illustrates schematically a water wave energy concentration system 1100 in accordance with embodiments of the present disclosure. The system 1100 can represent an implementation of one or more techniques described in this document.

In this detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “obtaining”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities.

Additionally, certain terms used in the present application may be better understood in view of the below explanations:

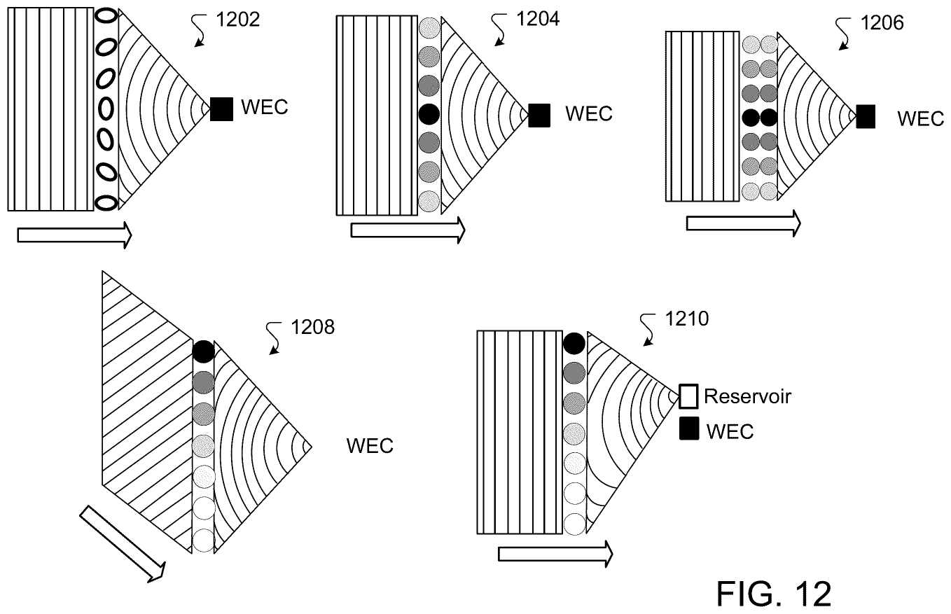

The term “array of wave interaction elements” may refer to a plurality of wave interaction elements disposed as a row (mono-dimensional array as shown for example in FIG. 12 items 1202 and 1204) defining an array direction axis or to a plurality of wave interaction elements disposed as several contiguous rows (two-dimensional array as shown for example in FIG. 12 item 1206).

The term “wave interaction element” may refer to a mechanical structure intended to be placed in the water floating at water surface level or submersed in the water. A depth of the wave interaction element may be controllably varied relative to water surface level. An orientation of the wave interaction element may be controllably varied to controllably interact with an incident water wave. The wave interaction element may have an elongated shape extending along a longitudinal axis. The wave interaction element may be intended to be positioned in the water so that the longitudinal axis is oriented towards seabed. A wave interaction element cross section along the longitudinal axis may have an ovoid shape. As shown in FIG. 12 item 1202, the wave interaction element may be controllably rotatable relative to the longitudinal axis. In other words, the wave interaction elements can be designed individually with variable shapes, both vertically and radially, and can be raised, lowered or rotated to induce changing local interaction with the incoming waves. The positioning of the wave interaction elements may be controlled according to the characteristics of the incoming waves, so that the propagating wave will be focused, defocused or directed according to the desired outcome.

FIG. 11 illustrates a water wave energy concentration system 1100 according to some embodiments of the present disclosure. The system 1100 comprises an array of wave interaction elements 1102 disposed offshore (i.e., in the water e.g., in the ocean). The wave interaction elements are configured to alter a phase and/or an amplitude of a water wave incident on the array and are controllable in order to focus said incident water wave on a desired focal area 1104 such as a WEC or a reservoir.

The water wave energy concentration system 1100 comprises a controller apparatus 1106 for implementing a method according to the present disclosure. The controller apparatus can include a processor 1108 for computing control commands according to a method of the present disclosure, said control commands being implemented by an actuator module 1110 operatively coupled to the wave interaction elements array and configured for controlling said wave interaction elements.

The actuator module 1110 can be operatively coupled to the one or more wave interaction elements e.g., the one or more controllable wave interaction elements are configured to be operated by the actuator module. The processor 1108 can be operatively coupled to the actuator module 1110 e.g., the actuator module 1110 is configured to be operated by the processor 1108. For example, the actuator module and processor can be configured to exchange data via wired or wireless transmission. In some embodiments, the actuator module may include one or more actuators operatively coupled to the wave interaction elements and configured for controlling said wave interaction elements. In some embodiments, each wave interaction elements may be operatively coupled to an actuator. In some embodiments, an actuator may be configured for controlling several wave interaction elements. In some embodiments, the actuators may be integrated to the wave interaction elements or to a frame onto which the wave interaction elements may be mounted to.

The controller apparatus 1106 can be configured to obtain data indicative of one or more current water wave attribute of an incident water wave 1112 such as water wave propagation direction, water wave amplitude (height of wave crests) and/or water wave wavelength (e.g., distance between successive wave crests). In some embodiments, sensors (e.g., a camera, among others discussed in this disclosure) may be configured to provide said data. In some other embodiments, said data may be obtained from a marine forecast database for example via a communication network to which the controller apparatus may be connected with.

The controller apparatus may include an input port configured to receive a signal indicative of the obtained data. The processor may be operatively coupled to said input port so as to receive said signal. The processor may be configured to compute control commands for controlling dynamically one or more of said wave interaction elements to adjust the focusing of the incident water wave on the focal area using said obtained data (or data signal). The processor may provide the control commands to the actuator module for controlling the one or more wave interaction elements accordingly e.g., using said computed control commands. In other words, the wave interaction elements are piloted automatically by the controller apparatus.

The controller apparatus may run a control routine using the obtained data signal. The control routine may control the wave interaction elements according to a desired outcome such as: focusing the incident wave on a WEC, directing the focused wave to a storage zone or providing calm zone required for the protection of vessels, constructions, or bio-restoration marine-reserves by diverting the water wave. In some embodiments, the control routine may be overruled in case of meteorological event such as a storm. A calibration table providing a relationship between incident wave attribute(s) and control commands needed to adjust the DWMA for achieving the desired focus on the focal area may be provided. The calibration table may be derived from simulations and laboratory experiments. The input data of the wave characteristics (such as direction, wavelength, height) may be translated using the calibration table to individual changes in the depth and/or orientation of the array wave interaction elements so as to provide optimal focusing of the wave on the WEC.

The focusing of waves in general can be achieved by modulating an amplitude or a phase of the wave-front. The wave interaction elements of the wave interaction element array can be controlled to influence the amplitude and/or phase of the waves, to form variable focal distance as well directionality of the incoming wave. The amplitude modulation of the wavefront may cause a significant decrease in an energy of the propagating focused wave. Therefore, use of phase delay wave interaction elements is preferred over amplitude control wave interaction elements.

The focusing of the incoming wave on the WEC may cause an increase of the wave height at the WEC, namely concentrating the energy density of the wave, and may provide very low wave energy density elsewhere. Accordingly, it has two major benefits. It enables to reduce the number of WEC sub-units which are based on local wave energy density (such as attenuator, point absorber, oscillating wave surge converter). In addition, it enhances the productivity of integrating WECs, in which the height of the water column generated by the incoming wave is crucial for high conversion efficiency (such as oscillating water column overtopping/terminator device) by reducing their size and by increasing the height of the water column.

FIG. 12 illustrates several examples of wave manipulation according to some embodiments of the present disclosure. The wave interaction elements forming the array can take diverse shapes and operate according to various principles of operation. In some embodiments, the wave interaction elements may comprise rods (round or oval) or plates with constant or variable cross-section along their height, submerged or floating on water. As shown in FIG. 12 item 1202, a variable interaction with the incident wave, needed for dynamic control, may for example be achieved by rotating such oval shaped rods. As shown in FIG. 12 item 1204, in which a darker grey tone of a wave interaction element indicates a lower depth relative to the water surface level, in some other embodiments involving rods of substantially constant cross section, a variable interaction with the incident wave may be achieved by changing a depth of said wave interaction elements relative to water surface level. In other embodiments involving various other types of wave interaction elements, a variable interaction with the incident wave may be achieved by varying the local density of the wave interaction elements or by combining some or all of the above.

FIG. 12 item 1208 illustrates forming asymmetrical arrangement of wave interaction elements in the DWMA for focusing an incoming wave propagating in a direction (illustrated by arrow) not perpendicular to a wave interaction element array direction axis. Consequently, the DWMA is programmed with an asymmetrical arrangement of the wave interaction elements. The concept of the dynamic DWMA is based on the fact that wave interaction elements, such as rods of larger cross section in respect to the incoming wave, or objects less submerged below the sea level introduce higher degree of phase delay in a propagating sea wave. The design of variable delay array of wave interaction elements, that can be individually changed in real time, to provide equal phase delays on a WEC smaller than the wave front, enables wave focusing and diverting. Such phase manipulations are traditionally done on electromagnetic wave by lenses, phased arrays and spatial light modulators.

FIG. 12 item 1210 illustrates directing of surplus of wave energy to a near coast storage reservoir. Other use of the presently disclosed method may provide low wave areas to protect vessels and shore and offshore constructions in stormy weather. The diverting of the wave to a storage container may enable a better match between the energy production and the energy demand along the day.

The input to the feedback loop with the characteristics of the incoming wave can be diverse as well. It can rely on local wave weather forecast and local wave statistics. It can rely on set of sensors, providing incoming wave characteristics in real time. The analysis of the forecast is fed to a control system which will change the control wave interaction elements, according to the desired outcome such as: focusing the income wave on the WEC, directing the focused wave to a storage zone or providing calm zone required for the protection of vessels, constructions, or bio-restoration marine-reserves.

As shown for example on FIG. 12 item 1204, when the direction of the incoming wave is perpendicular to the structure of the DWMA, the array of wave interaction elements may be symmetric. A central wave interaction element may provide the largest phase delay for example by being least submerged in the embodiments using an array with wave interaction elements of varying depth relative to water surface level. In these embodiments, a submersion of the peripheral wave interaction elements may increase symmetrically from the central wave interaction element resulting in a smaller delay of the peripheral wave interaction elements relative to the central wave interaction element. This arrangement enables to focus the wave to the WEC situated in front of the DWMA, as shown in FIG. 12 item 1204. When data indicative of the wave attribute (e.g., using the forecast or the sensors) indicate a change in the wave propagation direction relative to the array direction axis, as in item 1208, the DWMA may change an arrangement of the array to form larger phase delays on the end of the DWMA in which the wave front will hit first, while maintaining focusing, so that a focused and diverted wave will hit the WEC. Similar change of direction may be utilized to direct the focused wave to a water reservoir, located separated from the WEC, as illustrated in item 1210.

The characteristics of wave, change over various time scales: over seasons, time in the day, and wave to wave variations. Most of these variations are taken into account by the DWMA. However, for engineering and economic reasons it might be useful to reduce the specifications relative to the response time of the DWMA by introducing modifications on the WEC. The presently disclosed subject matter includes also the concept of a compartmental sectioning of the WEC. For example, typically the WEC may include a turbine and a container divided into a plurality of adjacent compartments (e.g., three), wherein each compartment can be selectively coupled to the energy production turbine. By doing so, when small shifting of the focusing area occur due to small variations on the incident while the array is not adjusted, an adjacent compartment may be receiving the focused wave while only said adjacent compartment is coupled to the turbine. This may result in the water column height being retained without the need for changing the configuration of the wave interaction elements in the DWMA. Therefore, when a compartmental WEC is located at the focal area, the method according to the presently disclosed subject matter may include an overruling pattern in case of small variations of the incident wave attribute e.g., when without adjusting the array, the focused wave enables filling of a container compartment adjacent to the WEC container compartment at the focal area.

It is noteworthy that a typical wavelength of sea waves is 100-300 m and that the wavefront maintains linearity along several wavelengths i.e., 300-1000 m. This implies two modes of operations for the DWMA. The array may be operated in accordance with a slow mode of operation of the array (with a typical length of 500 m, parallel to the wave-front) in which adjusting of the wave interaction elements may be based on average data on the wave propagation at a particular time. In the slow mode of operation, input for the feedback loop may derive from wave forecast databases such as Windfinder®. Such standard applications provide wind speed, direction and wave height with a few hours resolution (e.g., 3 h resolution). However, databases with higher time resolution are available. The presently disclosed method may therefore include obtaining dynamically at a first update frequency data indicative of incident wave attributes based on forecast database and controlling dynamically, at a first adjustment frequency, the array to adjust the focusing of the incident water wave on the focal area using said data. The array may be also operated in accordance with a fast mode of operation based on local monitoring of individual waves (e.g., with adjustment every few second or every few minutes). If we want to take into account the distortion in the wave form and to correct for it, the DWMA can be longer and focus larger wave front. However, in this case a fast response DWMA is needed and the input to its operation is based on local monitoring of individual waves. The presently disclosed method may therefore include obtaining dynamically, a second update frequency higher than the first update frequency, data indicative of incident wave attributes based on local monitoring of the wave incident on the array (e.g., in real time) and controlling dynamically, at a second adjustment frequency higher than the first adjustment frequency, the array to adjust the focusing of the incident water wave on the focal area using said data. In some embodiments, wherein the array is capable of both the fast and slow mode of operations, the fast mode of operation may be disabled for example in exceptional circumstances, such as a meteorological event.

Sensors can be based on arrays of wave monitoring gauges or on camera analysis of wave prior to their arrival to the DWMA.

The average power of the device is only roughly estimated here: A reasonable average power of sea-waves along many coasts is 50 kW per meter. A DWMA of the length of 1 km with the efficiency of 50% and energy conversion at the WEC of 80%, resulting 40% total efficiency carries the potential of 20 MW average power. (1000 m*0.40*50 kW) A cluster of 10 DWMAs couple to 10 WECs along a coastline of 10 km will carry the potential of 200 MW average power, comparable in capacity to a large power station turbine.

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing any departure from the scope of the disclosure.

It will also be understood that the system according to the present disclosure may be, at least partly, implemented on a suitably programmed computer. Likewise, the present disclosure contemplates a computer program being readable by a computer for executing the method of the invention. The present disclosure further contemplates a non-transitory computer-readable memory tangibly embodying a program of instructions executable by the computer for executing the method of the present disclosure.

Also, it is to be understood that the phraseology and terminology employed herein are for the purpose of description and should not be regarded as limiting.

It should be noted that the words “comprising”, “including” and “having” as used throughout the appended claims are to be interpreted to mean “including but not limited to”. The indefinite articles “a” and “an,” as used herein in the specification and in the claims, unless clearly indicated to the contrary, should be understood to mean “at least one.” The phrase “and/or,” “and”, or “or” as used herein in the specification and in the claims, should be understood to mean “either or both” of the wave interaction elements so conjoined, i.e., wave interaction elements that are conjunctively present in some cases, and disjunctively present in other cases.

It is important, therefore, that the scope of the invention is not construed as being limited by the illustrative embodiments set forth herein. Other variations are possible within the scope of the present invention as defined in the appended claims. Other combinations and sub-combinations of features, functions, wave interaction elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

While this specification contains many specific implementation details, these should not be construed as limitations on the scope of the disclosure or of what may be claimed, but rather as descriptions of features that may be specific to particular examples of particular disclosure. Certain features that are described in this specification in the context of separate examples can also be implemented in combination in a single example. Conversely, various features that are described in the context of a single example can also be implemented in multiple examples separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the examples described herein should not be understood as requiring such separation in all examples. It should be understood that the described program components and systems can generally be integrated together in a single product or packaged into multiple products.

Particular examples of the subject matter have been described. Other examples are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method of manipulating waves using lensing, the method comprising:
capturing, by one or more sensors, environmental data of an aquatic environment, wherein the environmental data relates to one or more of a wind speed, a wind direction, a wave pattern, a wave spectra, a wave amplitude, or a wave direction;
analyzing, by one or more processors of a controller, the environmental data to identify a sensed environmental condition;
determining a configuration of a wave interference device in the sensed environmental condition, wherein the controller is communicatively coupled to the wave interference device; and
configuring the wave interference device to occupy the configuration.

2. The method of claim 1, comprising determining a desired manipulation of waves.

3. The method of claim 2, wherein determining the configuration comprises determining the configuration of the wave interference device in the sensed environmental condition according to a desired action.

4. The method of claim 1, wherein configuring the wave interference device comprises executing instructions, by the one or more processors, stored in a memory of the controller, the memory communicatively coupled to the one or more processors.

5. The method of claim 4, wherein executing the instructions comprises sending a signal to the wave interference device to move one or more structures of the wave interference device from a first position to a second position.

6. The method of claim 1, wherein configuring the wave interference device comprises moving one or more structures of the wave interference device in a translational or rotational direction or depth below sea level.

7. The method of claim 1, comprising predicting an approaching wave pattern.

8. The method of claim 1, comprising processing historical data stored in a memory of the one or more processors.

9. The method of claim 1, comprising processing topographic data.

10. The method of claim 1, comprising processing weather forecasting.

11. The method of claim 1, wherein analyzing comprises comparing the environmental data to environmental data stored on a memory of the controller.

12. A wave manipulation system for an aquatic environment, the system comprising:
a wave interference device comprising an interference structure arranged to concentrate, reflect, or deflect a wave;
a controller communicatively coupled to the wave interference device and configured to move the interference structure; and
a sensor communicatively coupled to the controller, the sensor configured to capture environmental data of the aquatic environment.

13. The system of claim 12, wherein the interference structure has an adjustable height.

14. The system of claim 12, wherein the interference structure is rotatable about an axis of rotation.

15. The system of claim 12, wherein the interference structure is a stream of bubbles provided by the wave interference device.

16. The system of claim 12, wherein the interference structure is pivotable about a pivot axis.

17. The system of claim 12, wherein the interference structure comprises a plurality of interference structures.

18. The system of claim 17, wherein a first interference structure of the plurality of interference structures is positioned at a different depth below a water surface than a second interference structure of the plurality of interference structures.

19. The system of claim 12, wherein the controller comprises a memory communicatively coupled to one or more processors, the memory storing executable instructions that, when executed by the one or more processors, causes the one or more processors to:
receive environmental data captured by the sensor;
analyze the environmental data to identify an environmental condition associated with the aquatic environment; and
send a signal to the wave interference device to occupy a position in response to the environmental condition.

20. The system of claim 12, wherein the interference structure moves from a first position to a second position in response to a command transmitted by the controller.

21. The system of claim 12, wherein the interference structure changes shape in response to a command transmitted by the controller.

22. The system of claim 12, wherein two or more of a plurality of interference structures change a spacing or a symmetry of arrangement to combine focal change or deflection.

23. The system of claim 12, wherein the environmental data relates to one or more of a wind speed, a wind direction, a wave pattern, a wave spectra, or a wave direction.

24. The system of claim 12, wherein the interference structure comprises a plurality of rods arranged in an elliptical arrangement.

25. The system of claim 12, wherein the interference structure comprises a plurality of fins.

26. The system of claim 12, wherein the interference structure has a varying cross-section extending along a length of the interference structure.

27. The system of claim 12, wherein the interference structure comprises a plurality of interference structures; and
wherein the system comprises a second set of plurality of interference structures spaced from the plurality of interference structures, wherein the second set is arranged in a shape different than the plurality of interference structures.
